(19) United States
(12) Patent Application Publication
(10) Pub. No.: US 2024/0214628 A1
(43) Pub. Date: Jun. 27, 2024

(54) SYSTEMS AND METHODS INVOLVING ARTIFICIAL INTELLIGENCE AND CLOUD TECHNOLOGY FOR SERVER SOC

(71) Applicant: Uniquify, Inc., Santa Clara, CA (US)

(72) Inventors: Joshua Jungho LEE, San Jose, CA (US); Samjung KIM, San Jose, CA (US)

(21) Appl. No.: 18/288,166

(22) PCT Filed: May 2, 2022
(86) PCT No.: PCT/US2022/027242

§ 371 Date: Oct. 24, 2023

Related U.S. Application Data
(60) Provisional application No. 63/184,576, filed on May 5, 2021.
(60) Provisional application No. 63/184,630, filed on May 5, 2021.

(30) Foreign Application Priority Data
Apr. 29, 2022 (WO) PCT/US2022/027035

(51) Int. Cl. H04N 21/431; G06F 15/78; G06F 16/583

(52) U.S. Cl. CPC H04N 21/4312; G06F 15/7807; G06F 16/583

(57) ABSTRACT

Example implementations described herein are directed to systems and methods for a server hub device that is configured to execute artificial intelligence/neural network models through processing input data and generating metadata or instructions to edge devices. In example implementations, the AI/NN operations are conducted through executing logical shifts (e.g., by shifter circuits) on log-quantized parameters corresponding to such operations.

### CROSS REFERENCE TO RELATED APPLICATION(S)

This application claims the benefit of and priority to U.S. Provisional Application Ser. No. 63/184,576, entitled “Systems and Methods Involving Artificial Intelligence and Cloud Technology for Edge and Server SOC” and filed on May 5, 2021, U.S. Provisional Application Ser. No. 63/184,630, entitled “Systems and Methods Involving Artificial Intelligence and Cloud Technology for Edge and Server SOC” and filed on May 5, 2021, and PCT Application no. PCT/US22/27035, entitled “IMPLEMENTATIONS AND METHODS FOR PROCESSING NEURAL NETWORK IN SEMICONDUCTOR HARDWARE” and filed on Apr. 29, 2022, the disclosures of which are expressly incorporated by reference herein in its entirety.

### BACKGROUND

### Field

The present disclosure is generally directed to systems and architectures for artificial intelligence/neural network (AI/NN) processing, and more specifically, to systems and methods involving AI and cloud technology for server system on chip (SoC).

### Related Art

There are many forms of digital content today. First to define the term, “digital content” is any visual, audible, and textual content that consumers digest. As an example, television (TV) digital content involves images, videos, sound, and texts. The delivery mechanisms for these digital contents include, ethernet, satellite, cables, cell phone network, internet, and WIFI, and/or the like. The devices that are used to deliver the contents may include Television (TV), mobile phone, automobile display, surveillance camera display, personal computer (PC), tablet, augmented reality/virtual reality (AR/VR) devices, and various internet of thing (IoT) devices. Digital content can be also divided into “real-time” content such as live sporting events, or “prepared” content such as movies and sitcoms or other pre-recorded or non-live events. Today both “real-time” and “prepared” digital contents are presented to consumers without any further supplements or processing.

### SUMMARY

Example implementations described herein involve a novel approach to process digital content to gain intelligent information about the content, such as information that comes from object detection, object classification, facial recognition, text detection, natural language processing, and connect/annotate appropriate and relevant information found in the cloud/internet/anywhere with the parts of the digital content that is processed to be ready to be presented to the consumers. The example implementations provide a method of connecting/annotating processed digital content with the relevant and appropriate information found in the cloud/internet as implemented in hardware, software or some combination thereof.

Example implementations described herein further involve classifying visual and audio content. Example implementations classify/identify persons, objects, concepts, scenes, text, and language in visual content. Example implementations can convert audio content to text and identify relevant information within the converted text.

Example implementations described herein further involve obtaining any appropriate information from the cloud/internet and supplement the found information to the visual and audio content.

Example implementations described herein further involve presenting the supplemented content to consumers.

The classification/identification processes in example implementations described herein involve a step that processes image, video, sound, and language to identify people (e.g., who someone is), class of objects (such as car, boat, etc.), meaning of a text/language, any concept, or any scene. One example of a method that can accomplish this classification step is various artificial intelligence (AI) models that can classify images, videos, and language. However, there could be other alternative methods such as conventional algorithms.

In the present disclosure, “the cloud” can involve any information present in internet, any servers, any form of database, any computer memory, any storage devices, or any consumer devices.

Aspects of the present disclosure can involve a device, which can include a memory configured to store an object detection model in a form of a trained neural network represented by one or more log-quantized parameter values, the object detection model configured to classify one or more objects on image data through one or more neural network operations according to the log-quantized parameter values of the trained neural network; a system on chip (SoC), configured to intake the image data; execute the object detection model to classify the one or more objects from the image data through the one or more neural network operations, the one or more neural network operations executed by logical shift operations on the image data based on the one or more log-quantized parameter values read from the memory; and generate metadata for annotating the image data based on the classified one or more objects from the image data; and an interface configured to transmit the metadata to one or more other devices receiving the image data.

Aspects of the present disclosure can involve a computer program, which can include instructions involving intaking the image data; executing the object detection model to classify the one or more objects from the image data through the one or more neural network operations, the one or more neural network operations executed by logical shift operations on the image data based on the one or more log-quantized parameter values read from the memory; generating metadata for annotating the image data based on the classified one or more objects from the image data; and transmitting the metadata to one or more other devices receiving the image data. The computer program and instructions can be stored in a non-transitory computer readable medium for execution by one or more processors.

Aspects of the present disclosure can involve a method, which can include intaking the image data; executing the object detection model to classify the one or more objects from the image data through the one or more neural network operations, the one or more neural network operations executed by logical shift operations on the image data based on the one or more log-quantized parameter values read from the memory; generating metadata for annotating the image data based on the classified one or more objects from the image data; and transmitting the metadata to one or more other devices receiving the image data.

Aspects of the present disclosure can involve a system, which can include means for intaking the image data; executing the object detection model to classify the one or more objects from the image data through the one or more neural network operations, the one or more neural network operations executed by logical shift operations on the image data based on the one or more log-quantized parameter values read from the memory; means for generating metadata for annotating the image data based on the classified one or more objects from the image data; and means for transmitting the metadata to one or more other devices receiving the image data.

Aspects of the present disclosure involve a device, which can include a memory configured to store one or more trained neural network models, the one or more trained neural network models configured to process image data through one or more neural network operations; an interface; and a system on chip (SoC), configured to intake the image data; execute the one or more trained neural network models to process the image data through the one or more neural network operations; generate metadata for providing supplemental content for the image data based on the processing of the image data, the metadata generated based on information retrieved from a connection to another device through the interface; and transmit, through the interface, the metadata to one or more other devices that are intaking the image data.

Aspects of the present disclosure involve a device, which can include a memory configured to store one or more trained neural network models, the one or more trained neural network models configured to process image data through one or more neural network operations; an interface; and a system on chip (SoC), configured to intake the image data; execute the one or more trained neural network models to process the image data through the one or more neural network operations; generate metadata for providing supplemental content for the image data based on the processing of the image data, the metadata generated based on information retrieved from a connection to another device through the interface; and transmit, through the interface, the metadata to one or more other devices that are intaking the image data.

Aspects of the present disclosure involve a method, which can include intaking the image data; executing the one or more trained neural network models to process the image data through the one or more neural network operations; generating metadata for providing supplemental content for the image data based on the processing of the image data, the metadata generated based on information retrieved from a connection to another device through the interface; and transmitting, through the interface, the metadata to one or more other devices that are intaking the image data.

Aspects of the present disclosure involve a computer program, which can include instructions involving intaking the image data; executing the one or more trained neural network models to process the image data through the one or more neural network operations; generating metadata for providing supplemental content for the image data based on the processing of the image data, the metadata generated based on information retrieved from a connection to another device through the interface; and transmitting, through the interface, the metadata to one or more other devices that are intaking the image data. The computer program and instructions can be stored on a non-transitory computer readable medium and configured to be executed by one or more processors.

Aspects of the present disclosure involve a system, which can include means for intaking the image data; means for executing the one or more trained neural network models to process the image data through the one or more neural network operations; means for generating metadata for providing supplemental content for the image data based on the processing of the image data, the metadata generated based on information retrieved from a connection to another device through the interface; and means for transmitting, through the interface, the metadata to one or more other devices that are intaking the image data.

Aspects of the present disclosure can involve a device, which can involve a memory configured to store a trained neural network model represented by one or more log-quantized parameter values, the trained neural network model configured to conduct analytics on input data through one or more neural network operations according to the log-quantized parameter values of the trained neural network; and a system on chip (SoC), configured to execute the trained neural network model to conduct analytics on the input data through the one or more neural network operations, the one or more neural network operations executed by logical shift operations on the input data based on the one or more log-quantized parameter values read from the memory; and control another device based on the analytics on the input data through an interface.

Aspects of the present disclosure can involve a method involving executing the trained neural network model to conduct analytics on the input data through the one or more neural network operations, the one or more neural network operations executed by logical shift operations on the input data based on the one or more log-quantized parameter values read from the memory; and controlling another device based on the analytics on the input data through an interface.

Aspects of the present disclosure can involve a computer program involving instructions for executing the trained neural network model to conduct analytics on the input data through the one or more neural network operations, the one or more neural network operations executed by logical shift operations on the input data based on the one or more log-quantized parameter values read from the memory; and controlling another device based on the analytics on the input data through an interface. The computer program and instructions can be stored on a non-transitory computer readable medium and executed by one or more processors.

Aspects of the present disclosure can involve a system involving means for executing the trained neural network model to conduct analytics on the input data through the one or more neural network operations, the one or more neural network operations executed by logical shift operations on the input data based on the one or more log-quantized parameter values read from the memory; and means for controlling another device based on the analytics on the input data through an interface.

### BRIEF DESCRIPTION OF DRAWINGS

FIGS. 1A to 1C illustrate examples of an overall system architecture in accordance with example implementations.

FIG. 2 illustrates an example flow diagram of the server or hub device with AI SoC, in accordance with an example implementation.

FIG. 3 illustrates an example of supplemental metadata that can be provided alongside content by server or hub device with AI SoC, in accordance with an example implementation.

FIGS. 4A and 4B illustrate an example of supplemental metadata that can be provided alongside content by server or hub device with AI SoC, in accordance with an example implementation.

FIG. 4C illustrates an example of a mapping of output label to supplemental content, in accordance with an example implementation.

FIG. 5 illustrates an example architecture of the AI SoC, in accordance with an example implementation.

FIG. 6 illustrates an example circuit diagram of the AI Processing Element (AIPE), in accordance with an example implementation.

FIG. 7 illustrates an example of an AIPE array, in accordance with an example implementation.

FIG. 8 illustrates an example flow of an AI model architecture, in accordance with an example implementation.

FIG. 9 illustrates an example of digital content supplemented with cloud information and social media information, in accordance with an example implementation.

FIG. 10 illustrates an example of digital content supplemented with cloud information and e-commerce information, in accordance with an example implementation.

FIG. 11 illustrates an example of an output from a detection algorithm, in accordance with an example implementation.

FIG. 12 illustrates an example of customized digital content, in accordance with an example implementation.

FIG. 13 illustrates an example configuration of a server or hub device with AI SoC, in accordance with an example implementation.

FIG. 14 illustrates an example system upon which example implementations of the server/hub device of FIG. 13 can be implemented, in accordance with an example implementation.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Example implementations described herein involve the use of a novel AI SoC for server and broadcasting architectures. In the example implementations described herein, “real-time” digital content and “prepared” digital content are presented (e.g., broadcasted) to consumers without any further annotation or processing. The technology proposed in previous sections is a novel approach to process digital content and connect appropriate cloud information found for relevant parts of the digital content to present to the consumers. Example implementations can be implemented and used to create “supplemental data” and send such extra information along with the original digital content to the consumer.

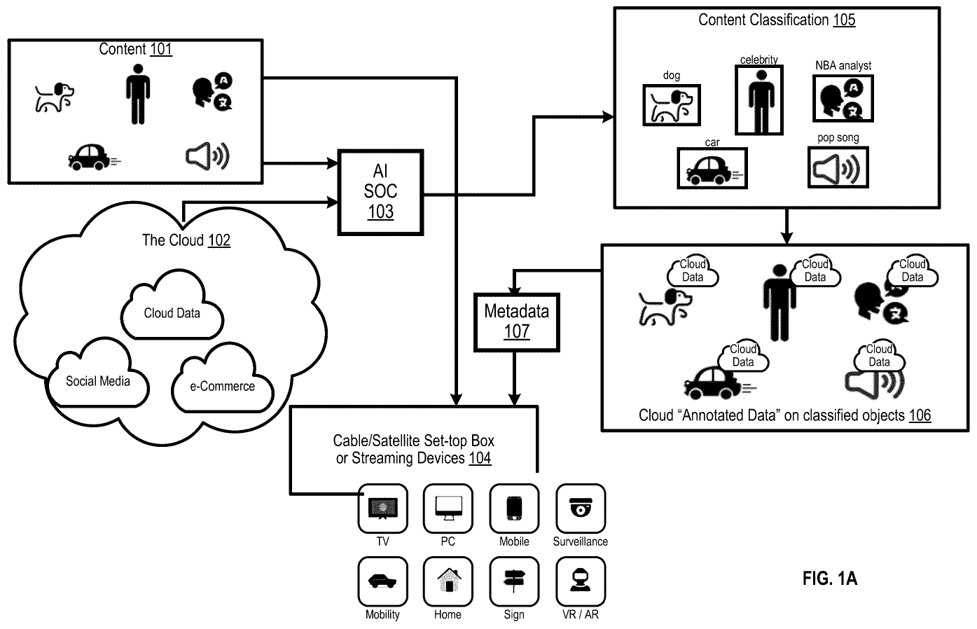

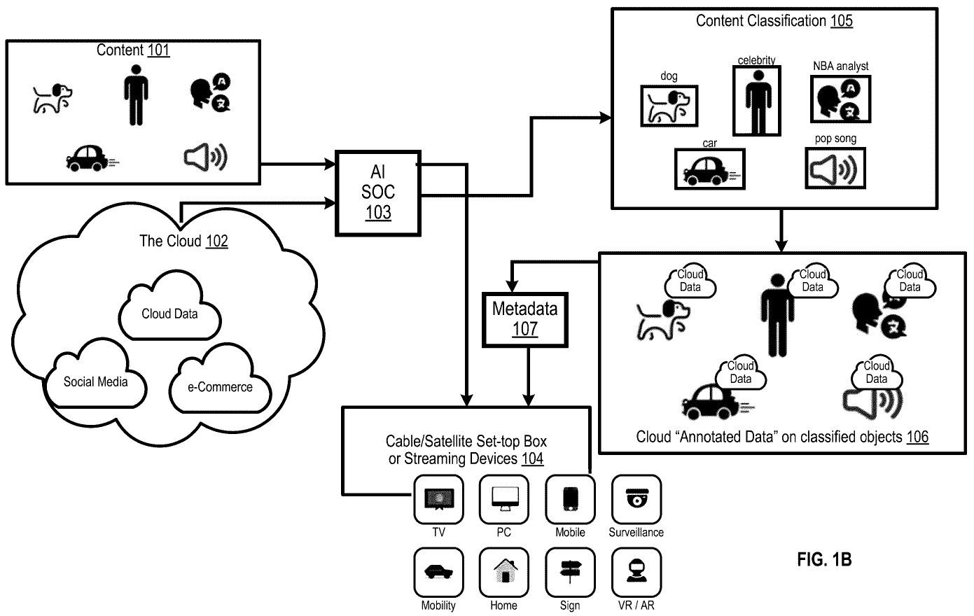

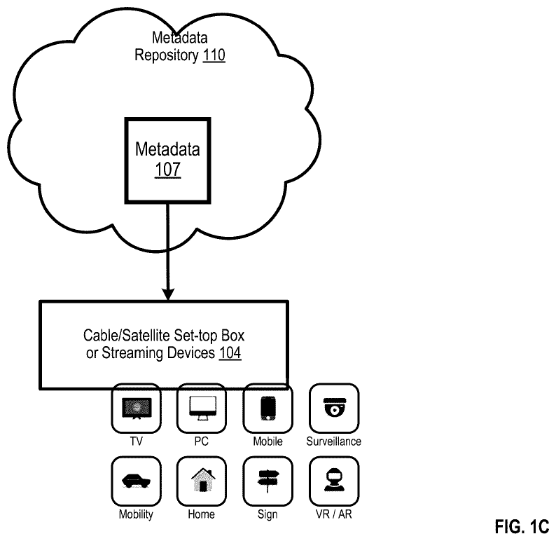

FIGS. 1A to 1C illustrate an overall system architecture in accordance with example implementations. In the system architecture as illustrated in FIG. 1A, content 101 is broadcasted to the edge device(s) 104 as well as to a server or other hub device that utilizes the AI SoC 103 as will be described herein. The content 101 can be broadcasted through any desired implementation, such as, but not limited to, satellite, TV, from a mobile device, camera (e.g., surveillance camera), from personal computers, and so on. The server or other hub device is configured to observe the content to be broadcasted to the edge device(s) 104 and process the content using AI/neural network (NN) models and other desired implementations to generate information to be used alongside the broadcasted content in the edge device(s) 104. In example implementations, content 101 can involve image data such as television video/audio data, streaming video, surveillance footage, and so on. However, the present disclosure is not limited thereto, and other content can also be broadcasted depending on the desired implementation and the underlying models to be used. For example, content can be audio, sensor data, depth camera image data, and otherwise.

Information from the cloud 102 or another internet resource is also provided to the server or other hub device that utilizes the AI SoC 103. Such information can involve data from a cloud resource, e-commerce information, social media information, web information, internet information, and so on in accordance with the desired implementation. The server or hub device utilizing AI SoC 103 processes the content and cloud information to pair appropriate information to be provided with the content. In example implementations involving video streaming data. In example implementations, the server or hub device utilizing AI SoC 103 classifies the video, audio, and text content using AI/NN models to generate content classification 105 to identify the video, audio, and text content. Based on the content classification 105, and the relevant and appropriate information from the cloud 102, supplemental data 106 is identified and used to generate metadata 107 to be provided to the edge devices 104 for use in edge processing of the received image data. In example implementations, aspects such as annotation by the edge devices can be achieved by metadata as will be described herein, which is used by the edge device(s) 104 to link cloud information 102 to received content 101.

Through such example implementations, the AI processing can be done by a dedicated server or other hub device which can act as the central hub for providing information from the cloud 102 to be used alongside broadcasted content, instead of processing from the edge device(s) 104. Further, through a novel approach of using logical shift operations in the AI SoC 103, the processing can be done seamlessly and fast (real time) at the server or hub device so the provided cloud information 102 can be provided to the edge device(s) 104 by the time the edge device(s) 104 are ready to display or otherwise use the received content 101. Through such example implementations, the edge device(s) 104 can display/use the received content 101 paired with cloud information 102 that otherwise would not have been possible in related art implementations due to the processing time required to do so. This is an improvement over related art implementations that require manual metadata annotations or manual metadata to be determined beforehand. Server or hub device with AI SoC 103 can provide such pairing to multiple different edge device(s) 104 processing multiple different content.

“real-time” and “prepared” digital contents 101 are delivered via connections such as ethernet, satellite, cables, local area network (LAN), Wide Area Network (WAN) and WIFI to the edge device(s) 104 which can include, but is not limited to, TV, mobile phone, automobile display, surveillance camera display, PC, tablet, AR/VR devices and various Internet of Things (IOT) devices.

FIG. 1B illustrates another example architecture in which contents 101 is provided alongside or with the metadata to the edge devices. In FIG. 1A, the contents 101 image data can be received by the edge device from some broadcasting device that is also broadcasting to the server or hub device managing the AI SoC 103. However, the contents 101 can be received from the server or hub device managing the AI SoC 103 if desired. In such an example implementation, the server or hub device can provide metadata alongside or incorporated in the contents 101 to the one or more edge devices.

FIG. 1C illustrates an example implementation involving a repository of already processed metadata, in accordance with an example implementation. In example implementations, the metadata may be reused for other devices that are receiving similar content 101. For example, if the server or hub device is managing a repository of digital content (e.g., a streaming application managing a library of video content to be provided to devices requesting the same video content), then metadata generated for some digital content in the repository can be reused for other edge devices that request the same digital content. In such an example implementation, a metadata repository 110 can be utilized to store metadata 107 for further reuse, which can be in the form of a cloud system, a database, storage systems, and so on in accordance with the desired implementation.

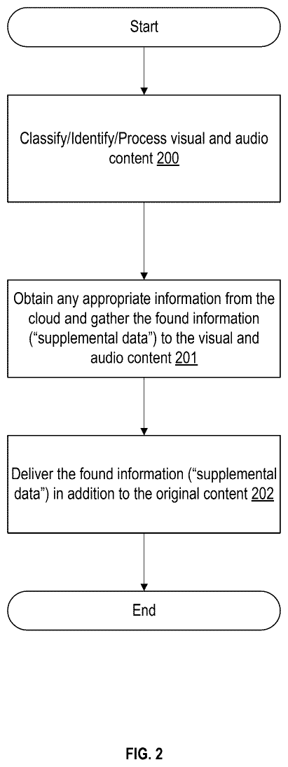

FIG. 2 illustrates an example flow diagram of the server or hub device with AI SoC, in accordance with an example implementation. Prior to delivering digital content, the content can be processed to go through following steps by the server or hub device with AI SoC.

Classify/identify/process visual, audio, and text content 200. The server or hub device with AI SoC in example implementations can classify/identify/process persons, objects, concepts, scenes, text, and language in visual content, and convert audio content to text and classify/process the text. AI, neural network, and any other conventional technologies can be used to achieve this step.

Obtain any appropriate information from the cloud and gather the found information (“supplemental data”) to the visual, audio, and text content 201.

Deliver the found information (“supplemental data”) in addition to the original content 202 to the edge devices for viewing. Depending on the desired implementation, “supplemental data” can be embedded into the digital contents or can be delivered separately to the receiving devices and the receiving devices can choose what “supplemental data” to display to the viewers.

In example implementations described herein the classification process at 200 and the gathering the appropriate information from the cloud at 201 can happen prior to the delivery of the digital content on a server or servers. Classification information and cloud information on classified objects are stored in a format that the receiving devices can understand. The receiving devices or applications that are running on the receiving devices choose what and how to display information on classified/processed objects received with the original content in accordance with the desired implementation.

Example implementations can also embed “supplemental data” to the original content medium. In related art implementations, the available image/audio/text file formats do not allow to embed extra information other than the main content such as video, audio, and text. A new file format can be employed to store visual, audio, text content and additional data such as the “supplemental data”. This new format can be the combination of “supplemental data” and original content data.

This process can happen one time and it can be stored for streaming/broadcasting later. This eliminates having to repeat this process over and over again every time a content is broadcasted or streamed. Further, the edge device(s) 104 can simply process the received content 101 and the received supplemental data (e.g., in the form of overlays) without having to conduct any additional AI processing.

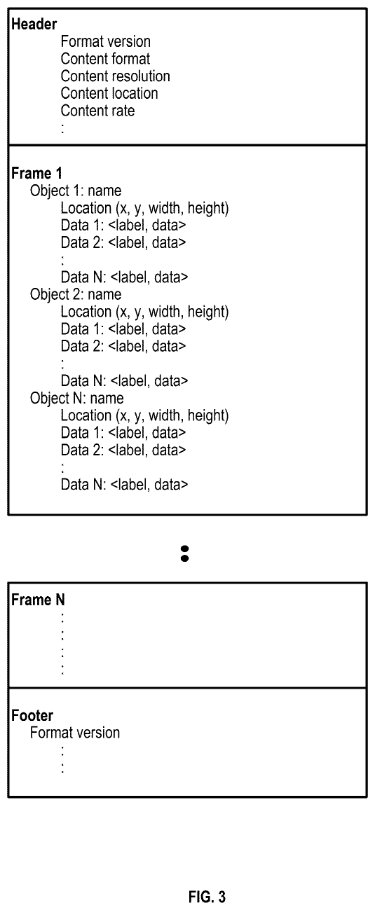

FIG. 3 illustrates an example of supplemental metadata that can be provided alongside content by server or hub device with AI SoC, in accordance with an example implementation. In an example of supplemental metadata that can be provided, the header can include information to identify the content that the rest of the metadata is to be associated with. The header can include information such as, but not limited to, format version, content format, content resolution, content size, content rate, and so on in accordance with an example implementation. The frame metadata can identify each object name and the coordinates of the object (Size), as well as any data that is to be associated with the object. Thus, supplementary data from the cloud can be described with respect of the output per particular frame of the content for any image or video content.

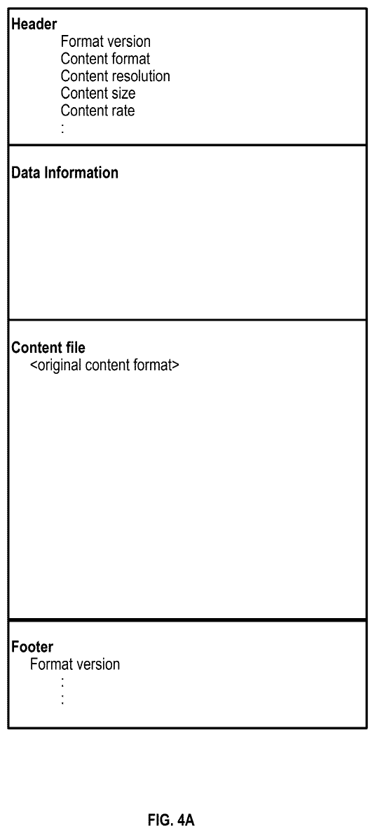

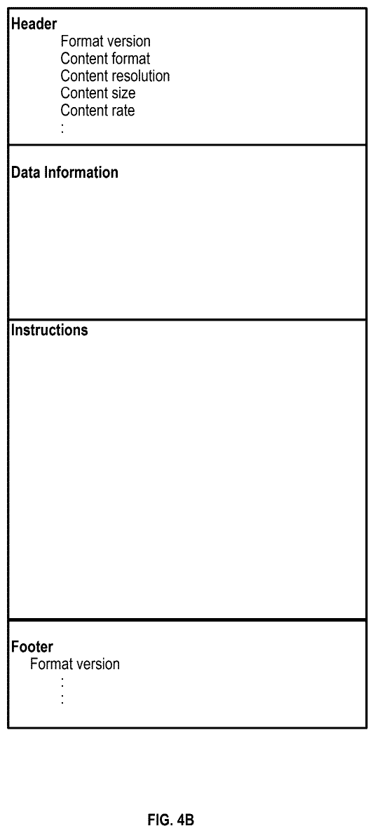

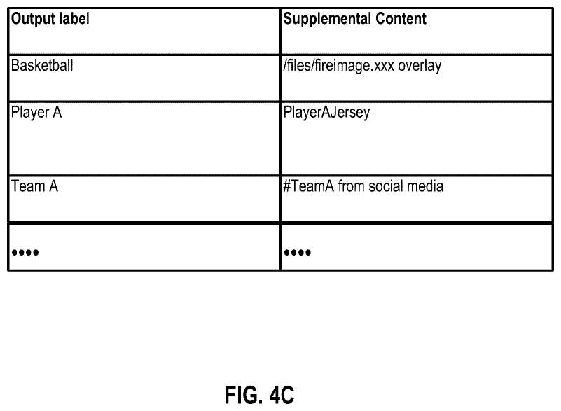

FIG. 4A and FIG. 4B illustrate examples of supplemental metadata that can be provided alongside content by server or hub device with AI SoC, in accordance with an example implementation. Example implementations can be extended to beyond image or video content, and generalized to any form of content in accordance with the desired implementation (e.g., audio, network traffic, etc.) In such example implementations, the data information can include supplementary information and other information to be associated with the content being received, and the content can be provided in the content file for use by the edge device(s) 104. In this manner, the server or hub device can provide content alongside or integrated with the metadata if desired. In the example of FIG. 4B, the metadata can also include executable instructions that can be executed by the one or more edge devices (e.g., to cause a menu to pop up, to pan a camera in a different direction) in accordance with the desired implementation. In this manner, the edge device can execute instructions that is to go along the received content and metadata as needed. The concepts of the example implementations illustrated FIGS. 3, 4A, and 4B can be combined in any way to facilitate the desired implementation.

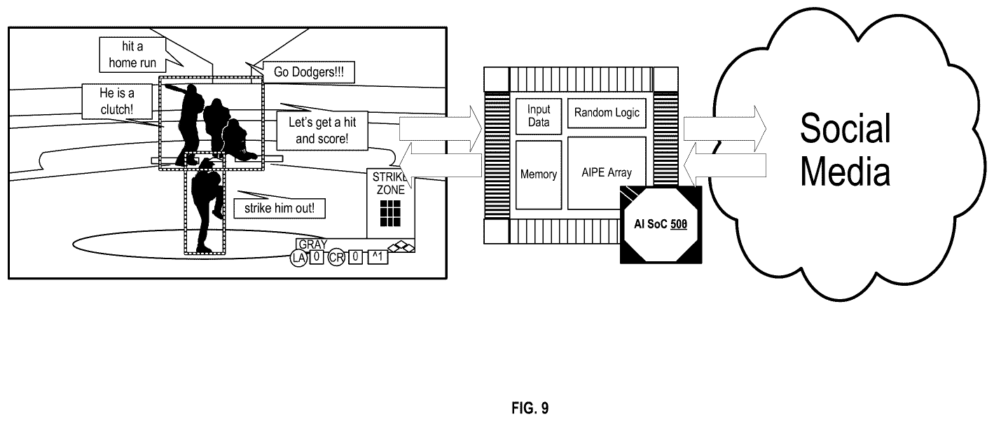

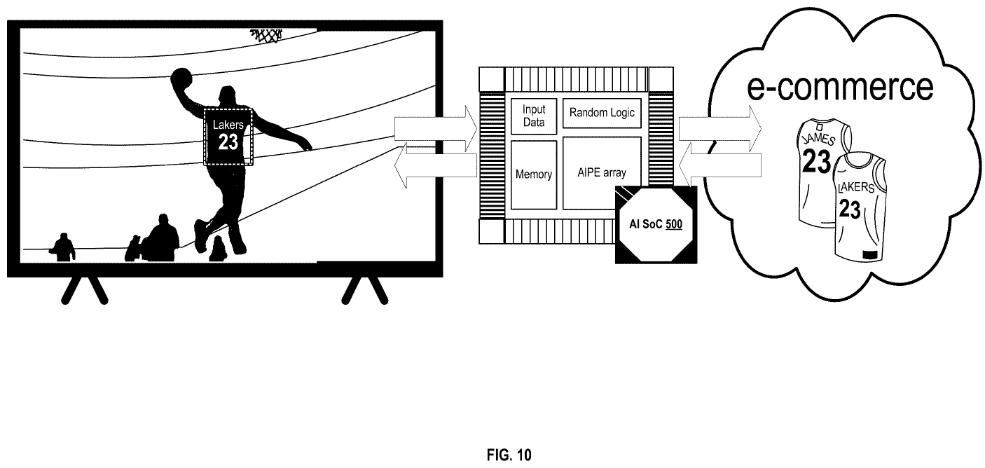

FIG. 4C illustrates an example mapping of output labels of one or more neural network models/AI models to supplemental content, in accordance with an example implementation. The one or more neural network models/AI models can be trained to process the input data for any purposes (e.g., object classification, text recognition, natural language processing, etc.) to produce one or more output labels along with their coordinates which can be provided in metadata form as illustrated in FIGS. 3, 4A and 4B. The output labels can be mapped to supplemental content to be provided (e.g, overlays, social media posts, images, audio, pop-up menus, etc.) to be provided alongside the content 101. For example, using an object classification model (e.g., constructed from a trained neural network model) that classifies an object as a basketball can be mapped to a fire image as supplemental content to be used as an overlay. Audio recognition (e.g., constructed from trained neural network model/AI model) to recognize Player A being uttered by an announcer can be mapped to supplemental content involving objects available for purchase that are related to Player A, such as a jersey as illustrated in FIG. 10. While Team A is recognized as playing on the screen on offense, such output labels can be mapped to social media posts to be used as an overlay as illustrated in FIG. 9. Further, depending on the desired implementation, supplemental content can also involve executable instructions (e.g., generate pop up menu for objects available for purchase, retrieve social media post from internet, etc.) that are incorporated into the metadata and transmitted to the edge devices for execution.

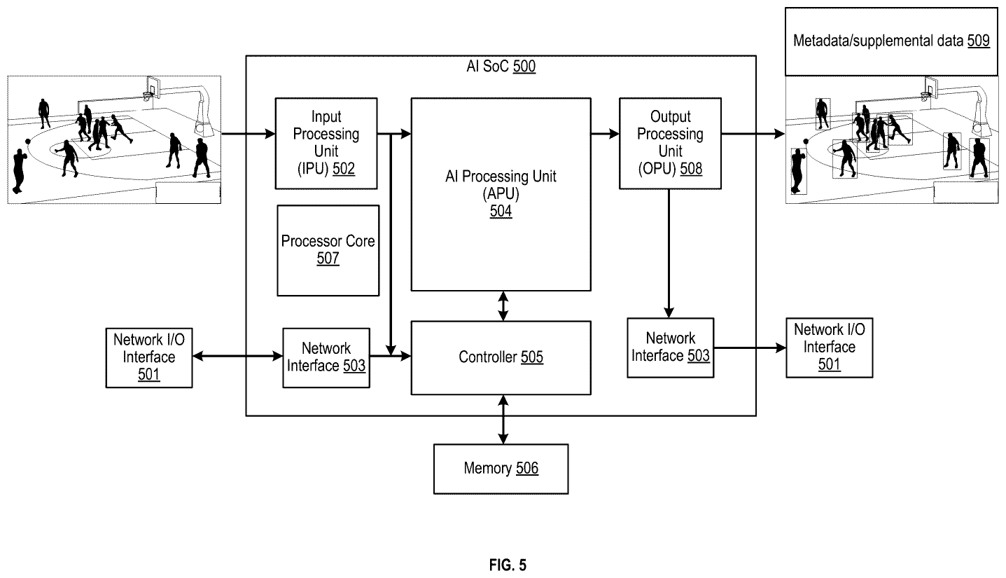

FIG. 5 illustrates an example architecture of the AI SoC, in accordance with an example implementation. AI SoC 500 can include several components as described herein.

Input processing unit 502 is configured to intake input of broadcasted content for processing by the AI/NN models. Such broadcasted content can include, but is not limited to, video, images, data, audio, text, and so on in accordance with the desired implementation. To be processed by the AI processing unit 504, the input processing unit 502 can be configured to convert the content into a matrix of values for processing by the appropriate AI/NN model, Network interface 503 is configured to interface with the Network Input/Output (I/O) interface 501 to intake data from cloud, internet or other external data sources, as well as to provide output (e.g., metadata/supplemental data 509) to edge devices via output processing unit 508. Network I/O interface 501 can be a separate hardware component installed on the server or hub device, or otherwise in accordance with the desired implementation. Processor core 507 can involve one or more IP cores to read instructions and execute processes accordingly on behalf of the AI SoC 500.

Controller 505 is a memory controller that is configured to load AI/NN models from memory 506 for processing by AI SoC 500. In an example implementation, the memory 506 can be in the form of Double Data Rate Synchronous Dynamic Random-Access Memory (DDR SDRAM), or can be other types of memory in accordance with the desired implementation. Likewise, controller 505 can be a DDR controller, but is not limited thereto.

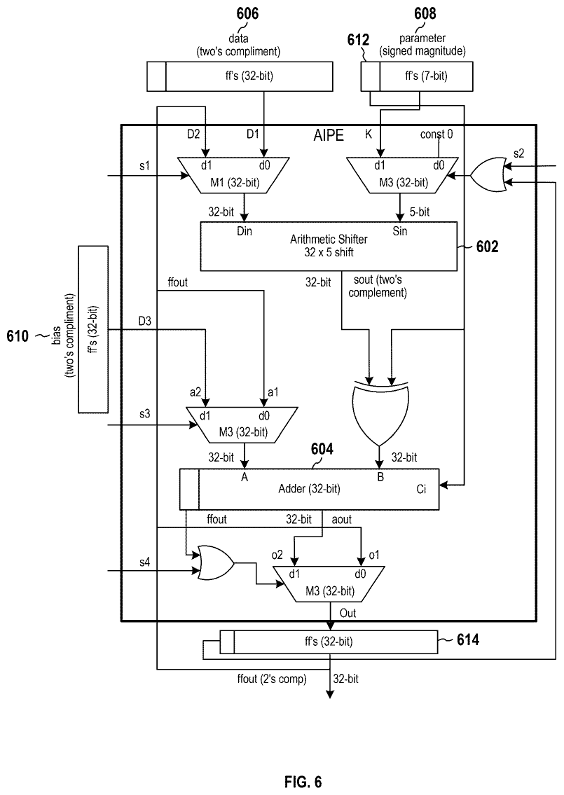

AI Processing Unit (APU) 504 is configured to execute the AI/NN models based on the parameters loaded from the controller 505 to conduct functions such as, but not limited to, object classification, object detection, object segmentation, facial recognition, or other types of AI/NN models in accordance with the desired implementation. In example implementations described herein, APU 504 can be composed of one or more AI processing elements (AIPEs) as illustrated in FIG. 6. To facilitate the processing of the AI/NN models in a timely manner so that the supplemental data/metadata can be provided to the edge devices as the edge devices receive the content, the APU 504 utilizes logical shift operations to process the log-quantized parameters of the AI/NN models instead of multiplication to process AI/NN models. In example implementations described herein, the parameters of the AI/neural network models are log-quantized (rounded to the nearest power of 2 in the form of 2^{round(log}₂^{X)} where X is the weight or bias parameter(s) of the AI/NN model), so that the log-quantized parameters can be converted to shift instructions to shift values according to the corresponding AI/NN operation needed by the model on the content as received by input processing unit 502. Through the use of logical shift operations as opposed to multiplication operations, it is possible to significantly save on processing time required to produce the output of the AI/NN models. Further, such operations can be facilitated by AIPEs utilizing physical hardware shifters in replacement of multiplier/accumulator (MAC) circuits, thereby saving on power consumption, time needed to process the models, footprint on the motherboard, and so on. However, APU can also be in the form of physical processors such as Central Processing Units (CPUs) or Field Programmable Gate Arrays (FPGAs) that are programmed to execute binary/logical shift operations on the received content to execute the AI/NN model processing, in accordance with the desired implementation. Further, any of the components of the AI SoC 500 can be implemented in the form of dedicated hardware elements for performing functions thereof in accordance with the desired implementation, including equivalent circuits and FPGAs.

Output processing unit 508 can involve instructions that utilize processor cores 507 to generate the corresponding metadata/supplemental data 509 as output, such as that illustrated in FIGS. 3, 4A and 4B. Such metadata/supplemental data can be used, for example, by the edge devices to generate additional information such as overlays to the viewers as illustrated in FIG. 5. Such instructions can involve converting the output to an output label based on a mapping of labels to output as indicated in the trained neural network/AI model, and then mapping such labels to supplemental content as illustrated in FIG. 4C to generate the metadata as illustrated in FIGS. 3, 4A, and 4B.

FIG. 6 illustrates an example of an AIPE for processing digital content, in accordance with an example implementation. The AIPE of FIG. 6 may comprise an arithmetic shift architecture in order to process the digital content. However, the disclosure is not intended to be limited to the arithmetic shift architecture disclosed herein. In some aspects, the AIPE may include adders and or multipliers to process the digital content. The AIPE of FIG. 6 utilizes an arithmetic shifter 602 and an adder 604 to process neural network operations, such as but not limited to convolution, dense layer, parametric ReLU, batch normalization, max pooling, addition, and/or multiplication. The arithmetic shifter 602 receives, as input, data 606 and shift instruction derived from the log-quantized parameter 608 to facilitate the logical shift operation. The data 606 may comprise 32-bit data in two's compliment format, while the shift instruction derived from log-quantized parameter 608 may comprise 7-bit data. For example, the arithmetic shifter 602 may comprise a 32-bit arithmetic shifter. The arithmetic shifter 602 shifts the data 606 based on the shift instruction derived from the log-quantized parameter 608. The output of the arithmetic shifter 602 goes through a two's compliment architecture and is added with a bias 610. The bias 610 may comprise a 32-bit bias. The adder 604 receives, as input, the output of the arithmetic shifter 602. The output of the arithmetic shifter 602 is in the form of two's compliment and is fed into an XOR and compared against a sign bit 612 of the shift instruction derived from the log-quantized parameter 608. If the sign bit 612 is negative, then the output of the arithmetic shifter 602 is flipped. The output of the XOR operation between the output of the arithmetic shifter 602 and the sign bit 612 is then fed into the adder 604. The adder 604 receives the bias 610, the output of the XOR operation between the output of the arithmetic shifter 602 and the sign bit 612 to add together. The adder 604 also receives, as input, the sign bit 612 as carry-in data. The output of the adder 604 is fed into a flip flop 614. The data of the flip flop 614 is fed back into the AIPE of FIG. 6. For example, the output of the flip flop 614 is fed into a multiplexor and is multiplexed with the data 606. The output of the flip flop 614 is also fed into a multiplexor and is multiplexed with the bias 610. The output of the flip flop 614 is also fed into a multiplexor and is multiplexed with the output of the adder 604. The output of the flip flop 614 may be in the form of two's compliment. A sign bit of the data of the flip flop 614 is also fed back into the AIPE. For example, the sign bit of the data of the flip flop 614 is fed into an OR operator and compared with a signal S2, where the result of the OR operation is fed into a multiplexor that multiplexes the parameter 608 and a constant 0 signal.

Variations of FIG. 6 to execute multiplication and other neural network operations through the use of shifters are also possible, and the present disclosure is not limited thereto. Examples of such can be found, for example, in PCT Application no. PCT/US22/27035, entitled “IMPLEMENTATIONS AND METHODS FOR PROCESSING NEURAL NETWORK IN SEMICONDUCTOR HARDWARE”, as filed on Apr. 29, 2022, the disclosure of which is expressly incorporated by reference herein in its entirety.

The above diagram is an example, and functional equivalents can be utilized to facilitate the desired implementation, such as through Field Programmable Gate Arrays (FPGAs), through replacement of such elements with other functional equivalents in hardware, or modified with additional elements to facilitate additional functionality in accordance with the desired implementation.

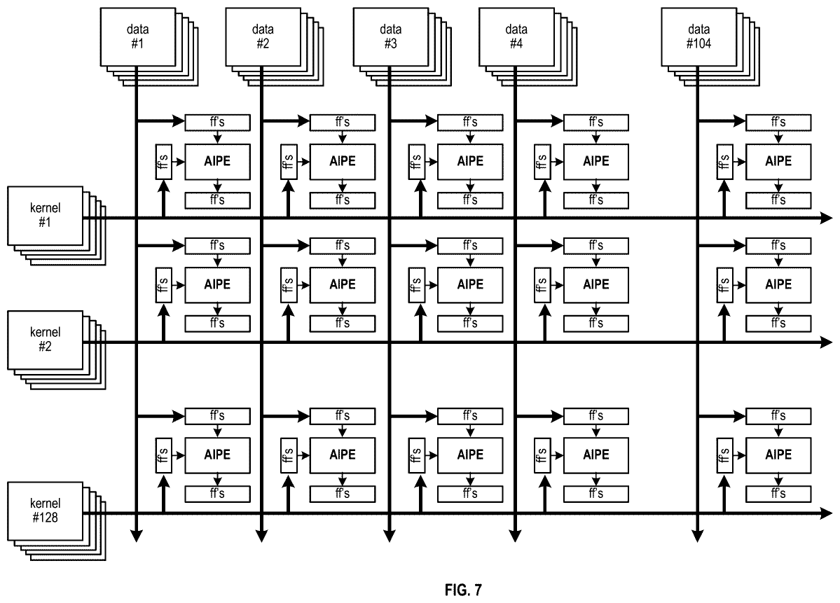

FIG. 7 illustrates an example of an AIPE array, in accordance with an example implementation. In the example of FIG. 7, the neural network array comprises a plurality of AIPEs where data and parameters (kernels) are inputted into the AIPEs to perform the various operations to process digital content, as disclosed herein. The AIPE architecture may comprise shifters and logic gates, but may be configured to utilize other elements and the disclosure is not intended to be limited to the examples disclosed herein. Examples disclosed herein comprise 32-bit data with 7-bit parameter, where data can be from 1-bit to N-bit and the parameter can be from 1-bit to M-bit parameter, where N and M are any positive integer. Some examples include a 32-bit shifter; however the number of shifters may be more than one and may vary from one shifter to O number of shifters where O is a positive integer. In some instances, the architecture comprises data 128-bit, parameter 8-bit, and 7 shifters connected in series—one after another. Also, the logic gates that are shown in herein are a typical set of logic gates which can change depending on a certain architecture.

In some instances, the AIPE architecture may utilize shifters, adders, and/or logic gates. Examples disclosed herein comprise 32-bit data with 7-bit parameter, data can be from 1-bit to N-bit and the parameter can be from 1-bit to M-bit parameter, where N and M are any positive integer. Some examples include one 32-bit shifter, and one 32-bit two input adder, however the number of shifters and adders may be more than one and may vary from one shifter to O number of shifters and one adder to P number of adders where O and P are a positive integer. In some instances, the architecture comprises data 128-bit, parameter 8-bit, and 2 shifters connected in series, and 2 adders connected in series—one after another.

The AIPE architecture disclosed herein may be implemented with shifters and logic gates where shifters replace multiplication and addition/accumulate operations. The AIPE architecture disclosed herein may also be implemented with shifters, adders, and logic gates where shifters replace multiplication and addition/accumulate operations. The AIPE architecture may be comprised of shifters to replace multiplication operations and logical function to replace addition/accumulation operations. The logic function to replace addition/accumulate operations is a logic function that is not a multiplier, adder, or shifter. However, in some aspects, the AIPE architecture may be comprised of multipliers, adders, and/or shifters. Accumulate operation can be thought of as a reduction operation where many numbers go into the accumulate operation and one number comes out as a result.

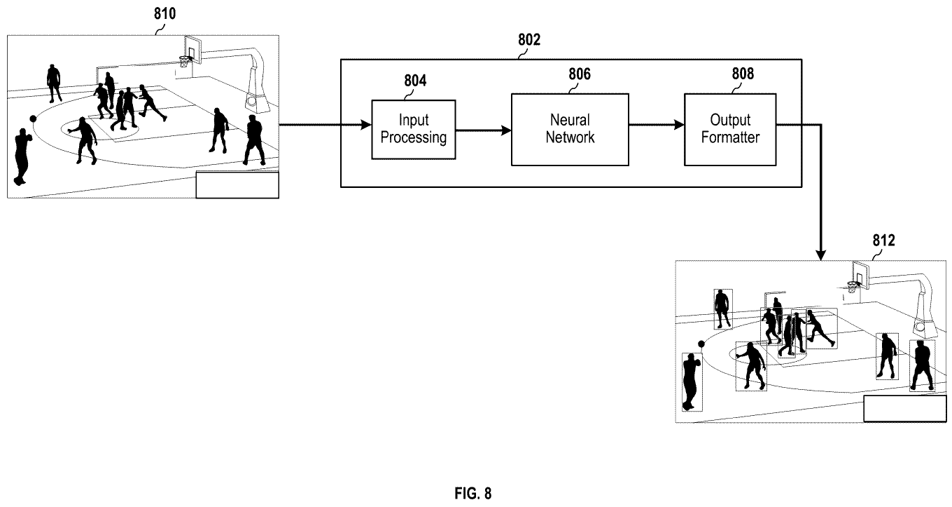

FIG. 8 illustrates an example flow of an AI model architecture, in accordance with an example implementation. The AI model architecture 802 includes input processing 804, neural network 806, and output formatter 808. The AI model architecture 802 may receive digital content 810 as input, where input processing 804 processes the digital content 810. The input processing 804 may process video of the digital content 810 as a plurality of frames or may process audio of the digital content 810 as speech. The input processing 804 may then provide the processed digital content 810 to the neural network 806. The neural network 806 may perform multiple operations on the processed digital content 810. For example, the neural network 806 may be configured to detect objects within the processed digital content. For example, the neural network 806 may detect one or more different objects within the digital content, such as but not limited to people, objects, text, or the like. The neural network 806 may generate one or more subframes for each of the objects detected.

The subframes of detected objects may be further processed by the neural network 806. For example, the neural network 806 may process the subframes to classify or identify the detected objects. The neural network 806 may classify or identify the detected objects and provide the information related to the classified or identified objects to the output formatter 808. In instances where the detected objects include people, the neural network 806 may process the subframes related to the detected people in an effort to identify the body parts of the person detected for example. For example, the neural network 806 may perform facial recognition or detection to identify the one or more detected people within the digital content.

In instances where the input processing 804 processes audio of the digital content, the neural network 806 may process the audio for speech recognition. The neural network 806 may process detected speech using a natural language processing. The natural language processing may detect or identify relevant information associated with the digital content. The detected relevant information obtained from audio of the digital content may be provided to the output formatter 808.

The output formatter 808 may utilize the output of the neural network 806 to provide a supplemented digital content 812 to be displayed. For example, the output formatter 808 may utilize the relevant information obtained from the audio of the digital content to display an advertisement, information, or the like, in the supplemented digital content 812 that is related to the relevant information obtained from the audio. In another example, the output formatter 808 may utilize information related to the one or more detected people within the digital content to display associated information related to the one or more detected people. For example, if the one or more detected people are athletes, then an advertisement for related sporting apparel (e.g., jerseys, uniforms, etc.) may be displayed in the supplemented digital content 812. In yet another example, the output formatter 808 may utilize information related to detected objects (other than detected people) and to display information within the supplemented digital content 812 related to the detected objects. For example, any detected text or item within the detected objects may be utilized by the output formatter 808 to display an advertisement or information related to the detected text or item.

Other implementations are also possible, and the present disclosure is not particularly limited to the implementations described herein. The AI SoC proposed herein can also be extended to other edge or server systems that can utilize such functions, including mobile devices, surveillance devices (e.g., cameras or other sensors connected to central stations or local user control systems), personal computers, tablets or other user equipment, vehicles (e.g., ADAS systems, or ECU based systems), Internet of Things edge devices (e.g., aggregators, gateways, routers), AR/VR systems, smart homes and other smart system implementations, and so on in accordance with the desired implementation.

FIG. 9 illustrates an example of digital content supplemented with cloud information and social media information, in accordance with an example implementation. In the example of FIG. 9, social media (e.g., social media posts) may be connected with the digital content such that information from social media may supplement the digital content. For example, users posting on social media applications that are tied into the digital content may be overlaid onto the digital content by the edge device after receiving the metadata/social media posts or appropriate instructions from the server/hub device described herein. The content from social media displayed with the digital content may be known as a social overlay. The social overlay may allow users to have a shared experience over social media over what people are watching on TV. For example, detected objects or people within the digital content may be overlaid with the social overlay. In some aspects, a player may be selected such that display items on the display may be provided along with the digital content. The supplemented digital content with the social overlay may be posted onto social media. The items to be displayed as part of the social overlay may be random or preconfigured.

FIG. 10 illustrates an example of digital content supplemented with cloud information and e-commerce information, in accordance with an example implementation. In some aspects, detected objects within the digital content may be related to e-commerce applications. For example, in a real-time sporting event, a jersey, uniform, or athletic apparel may be detected within the digital content, such that the detected jersey, uniform, or athletic apparel may trigger a link to purchase a similar or related jersey, uniform, or athletic apparel. The link may be selected such that an interface to an e-commerce website may be displayed on the display device along with the digital content by the edge device after being provided proper metadata or instructions thereon by the server/hub device. In an example implementation, the instructions can involve instructions for generating a menu on a graphical user interface (GUI) managed by the application of the another device. For example, the metadata can include instructions as illustrated in FIG. 4B that when executed will cause a corresponding pop-up menu to appear on a GUI of the application (e.g., a pop-up menu to indicate a jersey or other object available for purchase, a menu to indicate a link is available for more information, etc.).

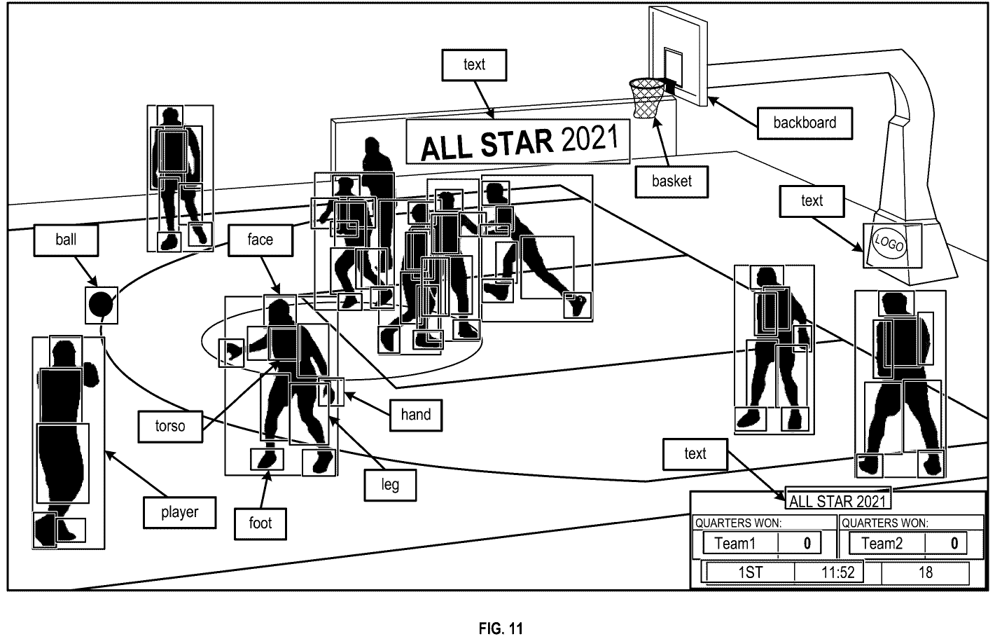

FIG. 11 illustrates an example of an output from a detection algorithm, in accordance with an example implementation. The detection algorithm may detect objects such as people within the digital content. For example, the detection algorithm may detect players, as well as body parts (e.g., hand, face, leg, foot, torso, etc.) of the detected players. The detection algorithm may also detect objects within the content, such as a ball, basket, or backboard. The detection algorithm may also detect text within the digital content, such as advertisements or scoring of players/teams involved in the digital content. The detection algorithm upon detection of people may further process the detected people in an effort to identify the player depending on the desired implementation and can provide the name of the player within the digital content. Once such objects/people are detected and classified, the appropriate metadata or instructions can be generated accordingly to control the edge device to execute some process based on the classified objects/people as shown in the examples herein. Example implementations can utilize any AI/NN based object detection, object recognition algorithm as known in the art to facilitate the desired implementation.

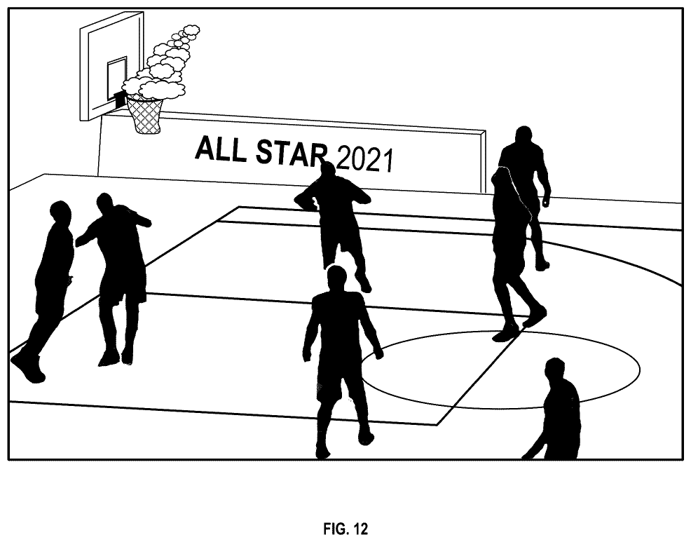

In an example of executing instructions or providing overlays based on the generated metadata, FIG. 12 illustrates an example of customized digital content, in accordance with an example implementation. In some aspects, upon the detection of an object within the digital content, the detected object may be modified to include a customizable overlay by the edge device after receiving metadata indicating the location of the detected object, or instructions to modify certain objects with overlays. For example, FIG. 12 provides an example of a real-time basketball game where the basketball has been detected. The basketball may be selected to include the customizable overlay, which in the example of FIG. 12 includes an overlay comprised of fire and smoke. In some instances, the basketball having the overlay of fire and smoke may be utilized to indicate that the shooter of the basketball is having a good game, such that the player is “on fire”. However, in some instances, many different overlays may be used in conjunction with the detected object, and the disclosure is not intended to be limited to an overlay comprised of fire and smoke.

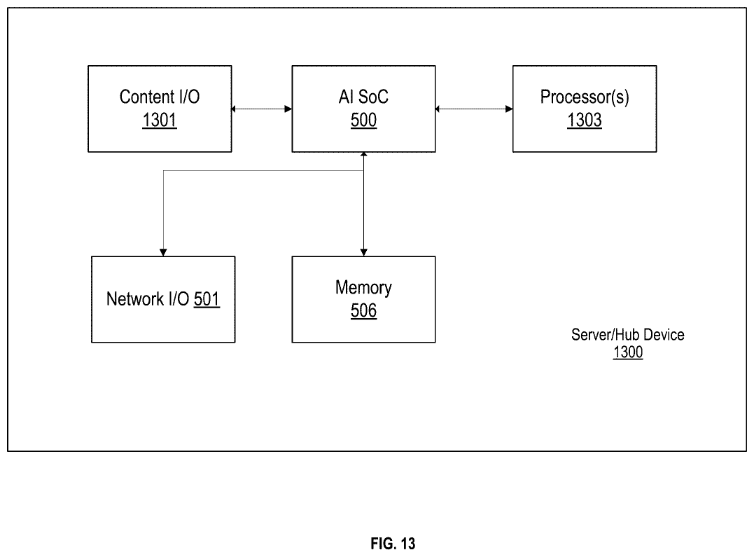

FIG. 13 illustrates an example configuration of a server or hub device with AI SoC, in accordance with an example implementation. In an example implementation the server/hub device 1300 can include a content I/O 1301, the network I/O interface 501, AI SoC 500, and memory 506 as described with respect to FIG. 5, processor(s) 1303, and so on in accordance with the desired implementation.

Content I/O 1301 can be configured to provide direct content for processing by the AI/NN models through the AI SoC 500. Depending on the desired implementation, content I/O 1301 can include a direct image/video/audio interface (e.g., High-Definition Multimedia Interface (HDMI) input, analog input, audio input, camera feed from cameras, and so on), or can involve any other direct data interface requiring AI/NN model processing in accordance with the desired implementation (e.g., secured sensor data feed from local area network or via direct connection, satellite interface, radio interface, and so on). Further, example implementations can involve multiple sources of data, and the content I/O 1301 can involve several different interfaces to accommodate all of the data being received by the server/hub device 1300. For example, content I/O 1301 can be configured to receive any combination of image, audio, or data sourced from any number of same or different devices to facilitate the desired implementation.

Network I/O interface 501 can include any interface to connect to external data from the cloud or the internet, in accordance with the desired implementation. Such external data can be extracted from cloud databases, can involve log-quantized parameters to update the AI/NN models stored in memory 506, and so on in accordance with the desired implementation.

Server/hub device 1300 can involve any number of AI SoCs 500 in accordance with the desired implementation. Memory 506 can be configured to store the log-quantized parameters of the trained AI/NN models to be loaded into AI SoCs 500, so that AI SoCs 500 can execute the shift and/or add operations accordingly to execute the AI/NN models on the data to generate metadata for use by the edge devices. Processor(s) 1303 can be configured to load and execute any instruction to facilitate additional functionality thereon, such as converting output of the AI SoCs 500 to metadata, supplemental data, or other output in accordance with the desired implementation. Depending on the desired implementation, processor(s) 1303 can also be configured to load and execute instructions to convert output from the AI SoCs 500 into instructions for execution by a corresponding edge device, wherein such instructions can be transmitted to the corresponding edge device via network I/O interface 501. Such instructions can include instructions to control the edge device (e.g., turn the camera another angle, adjust motor revolutions of an air compressor, generate overlays or cause a menu to appear on a user interface, and so on).

In an example implementation, the server/hub device 1300 can be on a broadcasting side of a streaming television service, from which all streaming broadcasts are transmitted to edge devices and concurrently to the server/hub device 1300. The server/hub device 1300 can process the raw broadcast and execute AI/NN models accordingly to generate metadata/supplemental data for use by an application in the edge device. The application in the edge device can then use the metadata/supplemental data to generate overlays on the displayed content as illustrated in FIGS. 9 to 12, and so on. In another example implementation, the server/hub device 1300 can also generate instructions to transmit to the application on the edge device to call up a menu, interact with a mobile device or other device paired to the edge device (e.g., providing e-commerce or social media information to a paired mobile device), and so on in accordance with the desired implementation. Any number of server/hub devices 1300 can be utilized to facilitate such an example implementation, and multiple server/hub devices 1300 can be used in a similar manner as a cloud service provider to facilitate the desired implementation.

In example implementations, server/hub device 1300 can be configured to interact with/control one or more edge devices in a local network, to facilitate the desired implementation, or can function as an edge server to interact/control one or more edge devices over the cloud. In an example implementation of a server/hub device to control one or more edge devices in a local network, such implementations can be used in systems that require high privacy (e.g., home devices, smart factory floors, etc.) in which the data being transmitted requires AI/NN model processing but the data also is private. In an example, one or more home cameras can provide surveillance video feed to the server/hub device 1300, wherein software can be used to train AI/NN models to recognize desired members of the house (e.g., family member, pets, etc.). The AI/NN models are then log-quantized and stored into the memory of the server/hub device 1300 to facilitate a local security system without needing to transmit image data over the internet and/or without requiring that the server/hub device 1300 be connected to the internet, thereby increasing security of the data. Other devices may also interact with the server/hub device in accordance with the desired implementation, and the present disclosure is not limited thereto. For example, cameras and other sensors can be installed into a refrigerator to monitor goods and generate shopping lists, indicate when food items will expire, or recipes for the indicated goods in accordance with the desired implementation. Any desired implementation for implementing AI/NN models on data or other feedback from edge devices can be utilized.

In example implementations of the server/hub device 1300, memory 506 is configured to store one or more trained neural network models (e.g., object detection models, object recognition models, facial recognition models, etc.), each of which can be represented by one or more neural network operations (e.g., neural network layers) that may be composed of one or more log-quantized parameter values. In an example, object detection models can be configured to classify one or more objects on image data through such neural network operations as illustrated in FIG. 11. Server/hub device 1300 can also involve an AI SoC 500, which can be configured to execute a method or computer instructions involving intaking the image data (e.g., via IPU 502); executing (e.g., via APU 504) the one or more trained neural network models (e.g., object detection models, object recognition models, etc.) to process the received image data (e.g., classify the one or more objects from the image data) through the one or more neural network operations. As illustrated in FIG. 6, the one or more neural network operations can be executed by logical shift operations on the image data (e.g., via shift instructions derived from log-quantized parameter 608 on pre-processed image data 606) based on the one or more log-quantized parameter values read from the memory 506; and generate metadata for supplementing (e.g., via annotations or overlays as shown in FIGS. 9-11) the image data based on the output of the one or more neural network models (e.g., based on the classified one or more objects from the image data output from the object detection model as illustrated in FIG. 11). Server/hub device 1300 can involve an interface 501 configured to transmit the metadata (e.g., as shown in FIGS. 3, 4A, 4B) to one or more other devices (e.g., 1401) receiving the image data.

Depending on the desired implementation, metadata can involve information associated with one or more social media posts (e.g., illustrated in FIG. 9 as incorporated into FIG. 3, 4A, or 4B) to be provided on the image data as one or more overlays by the one or more other devices.

Depending on the desired implementation, the logical shift operations are executed by feeding shift instructions to the one or more shifter circuits of the AI SoC 500 as illustrated in FIG. 6. Similarly, add operations corresponding to the one or more neural network operations can also be executed by the one or more shifter circuits or one or more adder circuits in the AI SoC 500.

Depending on the desired implementations, the logical shift operations can be executed by a field programmable gate array (FPGA). That is, the FPGA can be programmed and configured as dedicated hardware to execute equivalent functions to that of the circuits and variations thereof of FIG. 6, as well as to facilitate any other functionality of the AI SoC 500 in accordance with the desired implementation.

Depending on the desired implementation, the logical shift operations can also be executed by one or more hardware processors such as central processing units (CPUs). That is, the AI SoC 500 can execute a computer program with hardware processors to execute the logical shift operations. Such example implementations can allow for the saving of execution cycles and power consumption to process the AI/NN operations should dedicated hardware not be available.

Depending on the desired implementation, the device 1300 can be a server and the image data can involve television video/audio data. In such example implementations, the television content can be broadcasted to edge devices such as a television, wherein the server can broadcast the metadata, the metadata and the television video/audio data, and so on in accordance with the desired implementation.

Depending on the desired implementation, the interface 501 can be configured to retrieve data from a content server (e.g., such as one or more content servers used to facilitate cloud 102, content servers facilitating internet retrievable supplemental content, content servers configured to provide supplemental content from a database, etc.), wherein the memory 506 is configured to store information mapping classified objects to data for retrieval from the content server as illustrated in FIG. 4C; wherein the AI SoC 500 is configured to read the information from memory and provide the corresponding mapping as the metadata based on the classified one or more objects from the image data.

Depending on the desired implementation, the information can map the classified objects to data related to objects available for purchase, as illustrated in FIGS. 4C and 10, and the AI SoC is configured to read the information from memory and retrieve corresponding ones of the objects available for purchase from the content server through the interface, the corresponding ones of the objects available for purchase provided as the information based on the classified one or more objects from the image data.

Depending on the desired implementation, the one or more neural network models can involve facial recognition models chat conduct facial recognition on the image data through one or more neural network operations according to the log-quantized parameter values of the trained neural network; wherein the AI SoC 500 is configured to generate the metadata based on identified faces from the facial recognition.

Depending on the desired implementation, the interface 501 is configured to retrieve the one or more log-quantized parameters from a server (e.g., one or more servers from cloud 102) and store the one or more log-quantized parameters in the memory. The log-quantized parameters can represent the one or more neural network/AI operations making up the one or more trained neural network/AI models that do the data processing.

Depending on the desired implementation, the metadata can involve an identifier for a frame in the image data, one or more objects identified in the frame by the object detection model, coordinates of the one or more objects identified in the frame, and data associated with the one or more objects identified in the frame as illustrated in FIGS. 3, 4A, and 4B.

Depending on the desired implementation, the data associated with the one or more objects identified in the frame can involve a social media post to be used as an overlay as illustrated in FIGS. 3, 4A, 4B, 4C and 9.

Depending on the desired implementation, the data associated with the one or more objects can involve one or more overlays retrieved from a content server as illustrated in FIG. 4C.

Depending on the desired implementation, the data associated with the one or more objects can involve executable instructions for execution by the one or more edge devices as illustrated in FIG. 4B.

In an example implementation, server/hub device 1300 can involve a memory 506 configured to store one or more trained neural network models, the one or more trained neural network models configured to process image data through one or more neural network operations; an interface 501; and a system on chip (SoC) 500, configured to execute a method or computer instructions to intake the image data; execute the one or more trained neural network models to process the image data through the one or more neural network operations as illustrated in FIG. 5; generate metadata for providing supplemental content for the image data based on the processing of the image data as illustrated in FIGS. 3, and 4A to 4C, the metadata generated based on information retrieved from a connection to another device (e.g., one or more content servers from cloud 102 of FIGS. 1A to 1C) through the interface 501; and transmit, through the interface 501, the metadata to one or more other devices (e.g., edge devices 104) that are intaking the image data.

Depending on the desired implementation, the metadata can involve information associated with one or more social media posts to be provided as the supplemental content on the image data as one or more overlays by the one or more other devices 104 as illustrated in FIG. 9. Such social media posts can be directed provided as content as illustrated in FIG. 4A, by executable instructions to receive such social media posts from an internet connection as illustrated in FIG. 4B, or can be conducted by the edge devices 104 based on a mapping as illustrated in FIG. 4C.

Depending on the desired implementation, the SoC 500 can be configured to execute the one or more trained neural network models by one or more shifter circuits in the SoC as illustrated in FIG. 6.

In another example implementation, the SoC is configured to execute the one or more trained neural network models by a field programmable gate array (FPGA) that is programmed to execute equivalent functions as the circuit of FIG. 6 (e.g., programmed to execute the one or more trained neural network models through one or more logical shift operations). In another example implementation, the SoC can be configured to execute the one or more trained neural network models by one or more hardware processors to perform equivalent functions to the circuit of FIG. 6 by computer instruction (e.g., execute the one or more trained neural networks through one or more logical shift operations). In such an example implementation, computing cycles and power can be saved on a hardware device despite not having the dedicated circuit as illustrated in FIG. 6 available.

Depending on the desired implementation, the device 1300 can be configured to transmit the image data to the one or more edge devices through the interface 501 as illustrated in FIG. 1B.

In example implementations, the server/hub device 1300 can involve a memory 506 configured to store one or more trained neural network models, the one or more trained neural network models configured to process image data through one or more neural network operations; an interface 501; and a system on chip (SoC) 500, configured to execute a method or instructions involving intaking the image data as illustrated in FIG. 5 (e.g., via IPU 502); executing the one or more trained neural network models to process the image data through the one or more neural network operations (e.g., via APU 504); generating instructions for execution (e.g., via OPU 508) by an application of one or more other devices based on the processing of the image data as illustrated in FIG. 4B; and transmitting, through the interface 501, the instructions to one or more other devices 104 that are intaking the image data.

In an example implementation, the instructions can involve instructions for generating a menu on a graphical user interface (GUI) managed by the application of the another device as described with respect to FIG. 10.

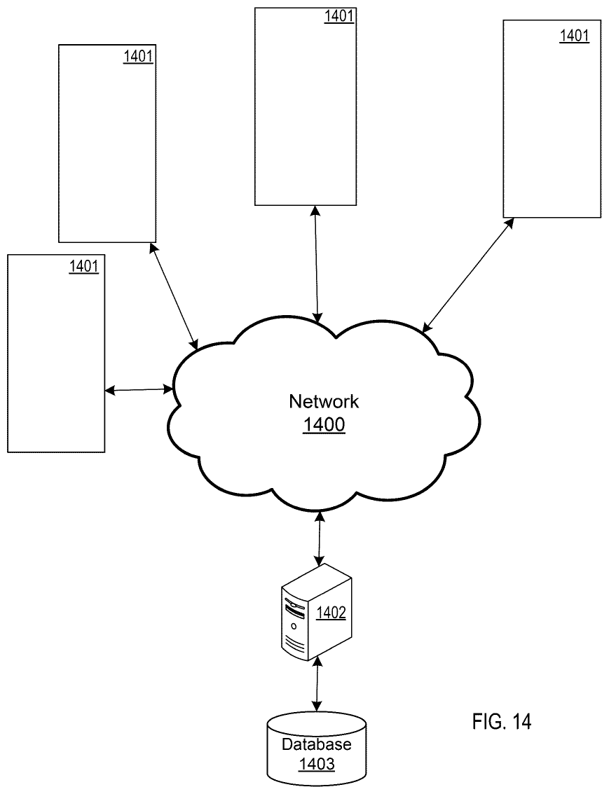

In example implementations, the server/hub device 1300 can involve a memory 506 configured to store a trained neural network model configured to conduct analytics on input data through one or more neural network operations according to the log-quantized parameter values of the trained neural network; and a system on chip (SoC) 500, configured to execute instructions or method that can include executing the trained neural network to conduct analytics on the input data through the one or more neural network operations, the one or more neural network operations executed by logical shift operations on the input data based on the one or more log-quantized parameter values read from the memory 506; and controlling another device based on the analytics on the input data through an interface 501, examples of which are described with respect to FIG. 14.

In example implementations, there can be systems and methods involving intaking image data to be transmitted to one or more devices (e.g., via IPU 502); executing one or more trained neural network models to process the image data through the one or more neural network operations (e.g., via APU 504); generating metadata for supplementing the image data based on the processing of the image data, the metadata generated based on information retrieved from a connection to another device (e.g., cloud 102); and transmitting the metadata to the one or more other devices, the one or more devices configured to provide one or more overlays on the image data according to the metadata (e.g., as illustrated in FIGS. 9 to 11).

FIG. 14 illustrates an example system upon which example implementations of the server/hub device of FIG. 13 can be implemented, in accordance with an example implementation. One or more edge/networked devices 1401 are communicatively coupled to a network 1400 (e.g., local area network (LAN), wide area network (WAN), WIFI, etc.) which is connected to a server/hub device 1402 as illustrated in FIG. 13. The server/hub device 1402 can connect to a database/cloud system 1403 via LAN or internet connection depending on the desired implementation. Such a database/cloud system 1403 can include data regarding the overlays which can be retrieved by the edge/networked devices 1401 based on the metadata provided, and/or can also include data provided by the edge/networked devices 1401 depending on the desired implementation. Database/cloud system 1403 can be implemented through one or more content servers or storage systems as is known in the art. Depending on the desired implementation, the system can also be implemented as an Internet of Things (IOT) system in which a plurality of heterogeneous devices can be managed or controlled by the server/hub device 1402 in accordance with the desired implementation.

In example implementations, the server/hub device 1402 can also be configured to conduct analytics by executing neural network models on behalf of the edge/networked devices 1401. In such example implementations, such edge/network devices 1401 can be configured to transmit data to the server/hub device 1402 for AI/NN model processing, wherein the server/hub device 1402 can conduct the appropriate processing and control the edge/networked devices through a transmission of instructions accordingly.

For example, in a security system, edge/networked devices 1401 can involve surveillance cameras, sound sensors, mobile devices, laptops, TVs, door sensors, and so on in accordance with the desired implementation. Video data or other data can be transmitted from edge/networked device 1401 to the server/hub device 1402 to be processed by AI/NN models configured to detect intruders on the AI SoC, wherein if the intruder is detected then the server/hub device 1402 can be configured to transmit instructions accordingly (e.g., instruct mobile device to retrieve video feed from surveillance camera) or transmit metadata accordingly (e.g., send metadata to mobile device regarding intrusion from indicated devices, wherein mobile device generates a message or loads a menu to indicate the indicated intrusions accordingly.

In another example, the server/hub device 1402 can be in the form of a programmable logic controller (PLC) on the factory floor to control multiple factory devices. In such an example implementation, such factory devices may transmit sensor data to the server/hub device 1402 which executes AI/NN models through the AI SoC according to the desired implementation to control such factory devices. For example, the AI/NN models may execute neural network models configured to conduct analytics and determine if a factory device is about to undergo failure, and if so the server/hub device 1402 can be configured to control such a factory device to power down to avoid further damage.

Other examples of analytics can also be possible in accordance with the desired implementation, and the present disclosure is not particularly limited. For example, sensor data from various devices from the factory line can be analyzed by the trained neural network model to adjust in accordance with the desired implementation. Other examples of modifications based on analytics can include sensors being reconfigured in response to analytics results, voice recognition parameters being changed in response to the analytics, and so on in accordance with the desired implementation.

The above example implementations can be extended to any networked environment and device in accordance with the desired implementation. One of ordinary skill in the art can utilize the example implementations described herein to generate metadata for processing by networked devices or to control such network devices with instructions in accordance with any desired implementation.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A device, comprising:
a memory configured to store one or more trained neural network models, the one or more trained neural network models configured to process image data through one or more neural network operations;
an interface; and
a system on chip (SoC), configured to:
intake the image data;
execute the one or more trained neural network models to process the image data through the one or more neural network operations;
generate metadata for providing supplemental content for the image data based on the processing of the image data, the metadata generated based on information retrieved from a connection to another device through the interface; and
transmit, through the interface, the metadata to one or more other devices that are intaking the image data.

2. The device of claim 1, wherein the metadata comprises information associated with one or more social media posts to be provided as the supplemental content on the image data as one or more overlays by the one or more other devices.

3. The device of claim 1, wherein the SoC is configured to execute the one or more trained neural network models by one or more shifter circuits in the SoC.

4. The device of claim 1, wherein the SoC is configured to execute the one or more trained neural network models by a field programmable gate array (FPGA).

5. The device of claim 4, wherein the FPGA is configured to execute the one or more trained neural network models through one or more logical shift operations.

6. The device of claim 1, wherein the SoC is configured to execute the one or more trained neural network models by one or more hardware processors.

7. The device of claim 6, wherein the one or more processors are configured to execute the one or more trained neural networks through one or more logical shift operations.

8. The device of claim 1, wherein the device is a server and wherein the image data is television video data.

9. The device of claim 1, wherein:
the another device is a content server;
wherein the memory is configured to store another information mapping output of processing of the image data by the one or more trained neural network models to the information retrieved from the content server;
wherein the SoC is configured to read the another information from memory and provide a corresponding mapping as the metadata.

10. The device of claim 9, wherein the information maps classified objects to information related to objects available for purchase;
wherein the SoC is configured to read the information from memory and retrieve corresponding ones of the objects available for purchase from the content server through the interface, the corresponding ones of the objects available for purchase provided as the information based on classified one or more objects from the image data classified by the one or more trained neural network models.

11. The device of claim 1, wherein the interface is configured to retrieve one or more log-quantized parameters from a server and store the one or more log-quantized parameters in the memory, the one or more neural network operations represented by the one or more log-quantized parameters;
wherein the SoC is configured to execute the one or more trained neural network models to process the image data through shift instructions derived from the one or more log-quantized parameters of the one or more neural network operations.

12. The device of claim 1, wherein the metadata comprises an identifier for a frame in the image data, coordinates within the frame, and data associated with the coordinates.

13. The device of claim 12, wherein the data associated with the coordinates comprises a social media post to be used as an overlay.

14. The device of claim 12, wherein the data associated with the coordinates comprises one or more overlays retrieved from a content server.

15. The device of claim 1, wherein the metadata comprises executable instructions for the one or more other devices.

16. The device of claim 1, wherein the device is configured to transmit the image data to the one or more other devices through the interface.
